(19) United States
(12) Patent Application Publication
(10) Pub. No.: US 2026/0067734 A1
(43) Pub. Date: Mar. 5, 2026

(54) ANALYTICS REPORTING SERVICES NEGOTIATION AND SETUP

(71) Applicant: Samsung Electronics Co., Ltd., Suwon-si (KR)

(72) Inventors: Rubayet Shafin, Frisco, TX (US); Boon Loong Ng, Plano, TX (US); Peshal Nayak, Plano, TX (US); Vishnu Vardhan Ratnam, Plano, TX (US); Yue Qi, Plano, TX (US); Bilal Sadiq, Plano, TX (US)

(21) Appl. No.: 19/310,842

(22) Filed: Aug. 26, 2025

Related U.S. Application Data
(60) Provisional application No. 63/689,433, filed on Aug. 30, 2024.
(60) Provisional application No. 63/712,847, filed on Oct. 28, 2024.
(60) Provisional application No. 63/713,885, filed on Oct. 30, 2024.

(51) Int. Cl. H04W 24/10; H04W 76/15

(52) U.S. Cl. CPC H04W 24/10; H04W 76/15

(57) ABSTRACT

A station (STA) includes a processor configured to establish a connection with an access point (AP), and generate a statistics report corresponding with the connection, the statistic report including at least one information set. The STA also includes a transceiver operably coupled to the processor. The transceiver configured to transmit the statistics report to the AP. The at least one information set may include at least one of a latency statistics report, a performance statistics report, and a channel occupancy report.

### CROSS-REFERENCE TO RELATED APPLICATION(S) AND CLAIM OF PRIORITY

This application claims priority under 35 U.S.C. § 119(e) to U.S. Provisional Patent Application No. 63/689,433 filed on Aug. 30, 2024, U.S. Provisional Patent Application No. 63/712,847 filed on Oct. 28, 2024, and U.S. Provisional Patent Application No. 63/713,885 filed on Oct. 30, 2024. The above-identified provisional patent applications are hereby incorporated by reference in their entirety.

### TECHNICAL FIELD

This disclosure relates generally to wireless networks. More specifically, this disclosure relates to analytics reporting services negotiation and setup.

### BACKGROUND

Wireless Local Area Network (WLAN) technology allows devices to access the internet in the 2.4 GHz, 5 GHz, 6 GHz or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax etc.

### SUMMARY

This disclosure provides apparatuses and methods for analytics reporting services negotiation and setup.

In one embodiment, a station (STA) is provided. The STA includes a processor configured to establish a connection with an access point (AP), and generate a statistics report corresponding with the connection, the statistic report including at least one information set. The STA also includes a transceiver operably coupled to the processor. The transceiver is configured to transmit the statistics report to the AP.

In another embodiment, an AP is provided. The AP includes a processor configured to establish a connection with a station STA. The AP also includes a transceiver operably coupled to the processor. The transceiver is configured to receive a statistics report corresponding with the connection from the STA. The statistics report includes at least one information set.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to various embodiments of the present disclosure;

FIG. 2A illustrates an example AP according to various embodiments of the present disclosure;

FIG. 2B illustrates an example STA according to various embodiments of this disclosure;

FIG. 3 illustrates an example wireless network where infrastructure traffic and non-infrastructure traffic coexist according to embodiments of the present disclosure;

FIG. 4 illustrates an example of statistics report sharing according to embodiments of the present disclosure;

FIG. 5 illustrates an example of ARS setup according to embodiments ofthe present disclosure;

FIG. 6 illustrates an example method for analytics reporting services negotiation and setup according to embodiments of the present disclosure; and

FIG. 7 illustrates another example method for analytics reporting services negotiation and setup according to embodiments of the present disclosure.

### DETAILED DESCRIPTION

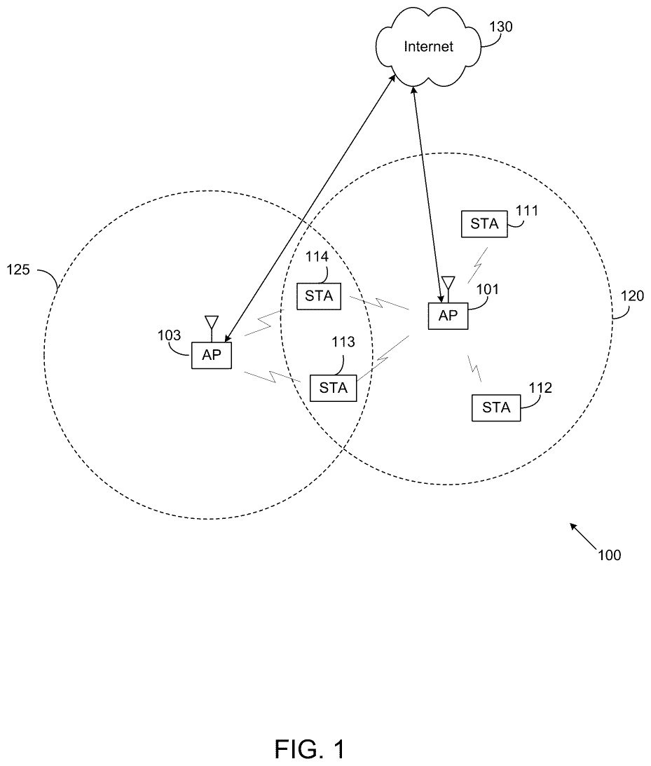

FIGS. 1 through 7, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged system or device.

Existing WLAN standards support multiple bands of operation, where an access point (AP) and a non-AP device may communicate with each other, called links. Thus, both the AP and non-AP device may be capable of communicating on different bands/links, which is referred to as multi-link operation (MLO). Devices capable of such MLO are referred to as multi-link devices (MLDs).

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for facilitating multi-link adaptation based on network quality monitoring. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

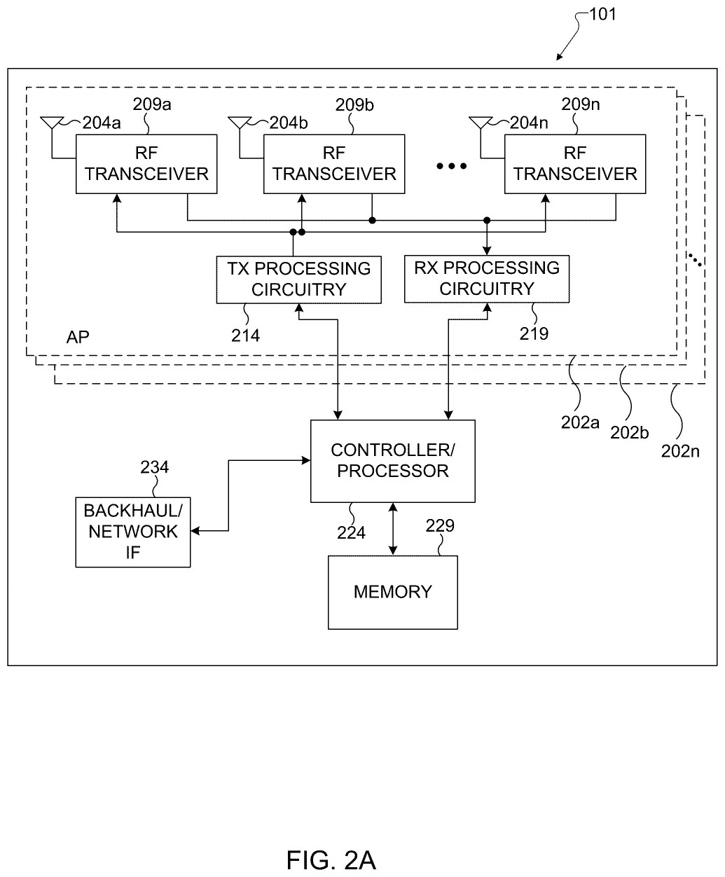

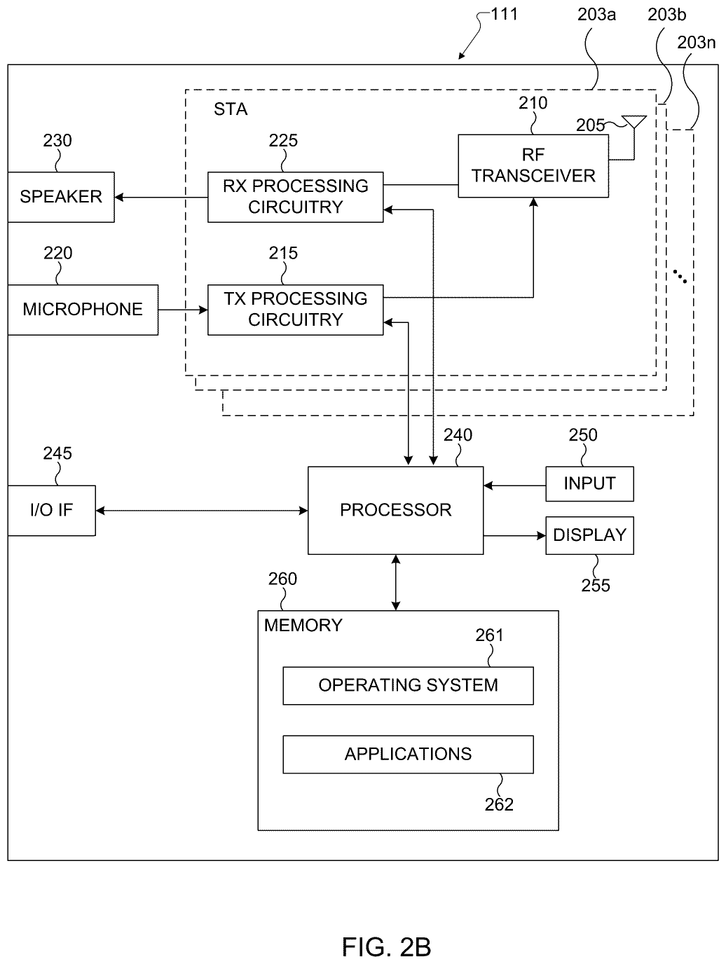

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. In the embodiments discussed herein below, the AP 101 is an AP MLD. However, APs come in a wide variety of configurations, and FIG. 2A does not limit the scope of this disclosure to any particular implementation of an AP.

The AP MLD 101 is affiliated with multiple APs 202a-202n (which may be referred to, for example, as AP1-APn). Each of the affiliated APs 202a-202n includes multiple antennas 204a-204n, multiple RF transceivers 209a-209n, transmit (TX) processing circuitry 214, and receive (RX) processing circuitry 219. The AP MLD 101 also includes a controller/processor 224, a memory 229, and a backhaul or network interface 234.

The illustrated components of each affiliated AP 202a-202n may represent a physical (PHY) layer and a lower media access control (LMAC) layer in the open systems interconnection (OSI) networking model. In such embodiments, the illustrated components of the AP MLD 101 represent a single upper MAC (UMAC) layer and other higher layers in the OSI model, which are shared by all of the affiliated APs 202a-202n.

For each affiliated AP 202a-202n, the RF transceivers 209a-209n receive, from the antennas 204a-204n, incoming RF signals, such as signals transmitted by STAs in the network 100. In some embodiments, each affiliated AP 202a-202n operates at a different bandwidth, e.g., 2.4 GHz, 5 GHz, or 6 GHz, and accordingly the incoming RF signals received by each affiliated AP may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP 202a-202n operates at a different bandwidth, e.g., 2.4 GHz, 5 GHz, or 6 GHz, the outgoing RF signals transmitted by each affiliated AP may be at a different frequency of RF.

The controller/processor 224 can include one or more processors or other processing devices that control the overall operation of the AP MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP MLD 101 by the controller/processor 224 including facilitating multi-link adaptation based on network quality monitoring. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP MLD 101 to communicate with other devices or systems over a backhaul connection or over a network. The interface 234 could support communications over any suitable wired or wireless connection(s). For example, the interface 234 could allow the AP MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP MLD 101 may include circuitry and/or programming for facilitating multi-link adaptation based on network quality monitoring. Although FIG. 2A illustrates one example of AP MLD 101, various changes may be made to FIG. 2A. For example, the AP MLD 101 could include any number of each component shown in FIG. 2A. As a particular example, an AP MLD 101 could include a number of interfaces 234, and the controller/processor 224 could support routing functions to route data between different network addresses. As another particular example, while each affiliated AP 202a-202n is shown as including a single instance of TX processing circuitry 214 and a single instance of RX processing circuitry 219, the AP MLD 101 could include multiple instances of each (such as one per RF transceiver) in one or more of the affiliated APs 202a-202n. Alternatively, only one antenna and RF transceiver path may be included in one or more of the affiliated APs 202a-202n, such as in other APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In the embodiments discussed herein below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antenna(s) 205, a radio frequency (RF) transceiver 210, TX processing circuitry 215, and receive (RX) processing circuitry 225. The non-AP MLD 111 also includes a microphone 220, a speaker 230, a controller/processor 240, an input/output (I/O) interface (IF) 245, a touchscreen 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives from the antenna(s) 205, an incoming RF signal transmitted by an AP of the network 100. In some embodiments, each affiliated STA 203a-203n operates at a different bandwidth, e.g., 2.4 GHz, 5 GHz, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205. In embodiments wherein each affiliated STA 203a-203n operates at a different bandwidth, e.g., 2.4 GHz, 5 GHz, or 6 GHz, the outgoing RF signals transmitted by each affiliated STA may be at a different frequency of RF.

The controller/processor 240 can include one or more processors and execute the basic OS program 261 stored in the memory 260 in order to control the overall operation of the non-AP MLD 111. In one such operation, the controller/processor 240 controls the reception of forward channel signals and the transmission of reverse channel signals by the RF transceiver 210, the RX processing circuitry 225, and the TX processing circuitry 215 in accordance with well-known principles. The controller/processor 240 can also include processing circuitry configured to facilitate EMLMR operations for MLDs in WLANs. In some embodiments, the controller/processor 240 includes at least one microprocessor or microcontroller.

The controller/processor 240 is also capable of executing other processes and programs resident in the memory 260, such as operations for facilitating multi-link adaptation based on network quality monitoring. The controller/processor 240 can move data into or out of the memory 260 as required by an executing process. In some embodiments, the controller/processor 240 is configured to execute a plurality of applications 262, such as applications for facilitating multi-link adaptation based on network quality monitoring. The controller/processor 240 can operate the plurality of applications 262 based on the OS program 261 or in response to a signal received from an AP. The controller/processor 240 is also coupled to the I/O interface 245, which provides non-AP MLD 111 with the ability to connect to other devices such as laptop computers and handheld computers. The I/O interface 245 is the communication path between these accessories and the controller/processor 240.

The controller/processor 240 is also coupled to the touchscreen 250 and the display 255. The operator of the non-AP MLD 111 can use the touchscreen 250 to enter data into the non-AP MLD 111. The display 255 may be a liquid crystal display, light emitting diode display, or other display capable of rendering text and/or at least limited graphics, such as from web sites. The memory 260 is coupled to the controller/processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted and additional components could be added according to particular needs. In particular examples, one or more of the affiliated STAs 203a-203n may include any number of antenna(s) 205 for MIMO communication with an AP 101. In another example, the non-AP MLD 111 may not include voice communication or the controller/processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

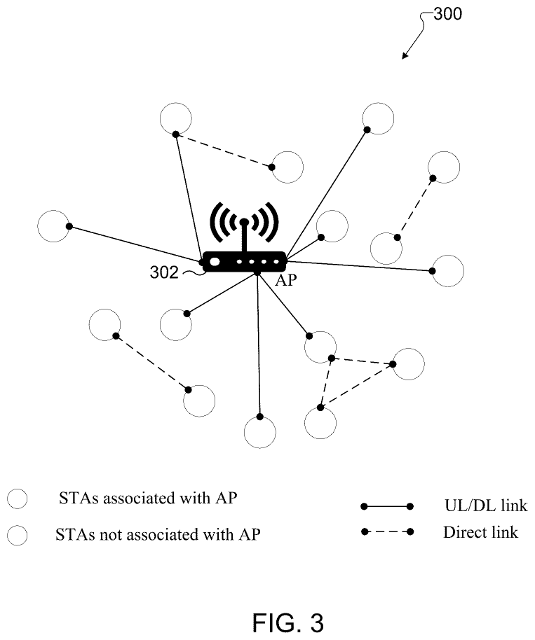

Better support for low-latency applications is desirable in next generation WLAN systems. It is not uncommon to observe numerous devices operating on the same wireless network. Many of such devices may be latency-tolerant but still contend with the devices with low-latency applications for the same time and frequency resources. In some cases, the AP as the network controller may not have enough control over the unregulated/unmanaged traffic that contends with the low-latency traffic within the infrastructure basic service set (BSS). Some of the unmanaged traffic that interferes with the AP's BSS's latency sensitive traffic may come from uplink (UL)/downlink (DL) or direct link communications within the infrastructure BSS that the AP manages. Other interference with the AP's BSS's latency sensitive traffic may be due to transmission in a neighboring infrastructure (overlapping) BSS (OBSS). Yet other interference with the AP's BSS's latency sensitive traffic may come from a neighboring independent BSS or P2P network as shown in FIG. 3.

FIG. 3 illustrates an example wireless network 300 where infrastructure traffic and non-infrastructure traffic coexist according to embodiments of the present disclosure. The embodiment of a wireless network of FIG. 3 is for illustration only. Different embodiments of a wireless network where infrastructure traffic and non-infrastructure traffic coexist could be used without departing from the scope of this disclosure.

In the example of FIG. 3, an AP 302 is associated with several STAs. The traffic between the AP and associated STAs is infrastructure traffic with respect to the network of AP 302. FIG. 3 also shows several STAs not associated with AP 302. Traffic generated by or transmitted to the STAs not associated with AP 302 is non-infrastructure traffic with respect to the network of AP 302.

Although FIG. 3 illustrates an example wireless network 300 where infrastructure traffic and non-infrastructure traffic coexist, various changes may be made to FIG. 3. For example, FIG. 3 could include additional APS, fewer or more STAs, etc. according to particular needs.

Existing wireless networks support enhanced stream classification services (SCS) procedures where a quality of service (QoS) characteristics element can be included in SCS request and SCS response frames. Under these enhanced procedures, a non-AP STA may send an SCS request frame with the QoS characteristics element to an AP, where the non-AP STA indicates the non-AP STA's traffic flow characteristics. The AP may then review the SCS request received from the non-AP STA and, upon acceptance, the AP provisions resources to the non-AP STA based on the traffic characteristics described in the QoS characteristics element included in the SCS request.

Once a non-AP STA has set up a QoS flow, for example through SCS setup, with its associated AP, constant exchange of performance metadata of QoS flow(s) between the AP and the STA provides for consistent QoS. This feedback loop allows the AP to adapt its service based on the STA's needs, network conditions, and location. Additionally, the STA can proactively utilize mechanisms to mitigate the impact of network degradation, thanks to this exchange of metadata. While features in existing wireless networks such as diagnostics, wireless network management (WNM) logs, and statistics reports provide a foundation, wireless networks would benefit from significant updates and additions to cater to the demands of modern and emerging applications like augmented reality (AR)/virtual reality (VR) and Internet of Things (IoT), which are highly latency-sensitive and specialized. Analytics reporting between APs and STAs can facilitate an overall improvement of the network performance.

In existing wireless networks, once a QoS flow has been set up between an AP and a non-AP STA, there is no mechanism that would allow the non-AP STA to periodically report the latency or performance statistics for the connection. Such statistics information can be very beneficial for overall performance enhancement and overall QoS assurance for the STA. Various embodiments of the present disclosure provide mechanisms and frameworks for a non-AP STA to send its latency statistics, performance statistics, radio frequency (RF) statistics, etc., to its associated AP.

In some embodiments, for the scenario where a first STA establishes a connection with its associated AP, the first STA can send a statistics report corresponding to the connection to the associated AP. The statistics report may contain different information sets. For example, the different information sets may include one or more of the following:
latency statistics report: The latency statistics report may contain different latency-related metrics for the latency or delay measured by the non-AP STA. For example, in some embodiments, the latency statistics may correspond to latency for the uplink traffic measured at the non-AP STA side.
performance statistics report: The link performance report may contain statistics information pertaining to the quality of a connection that the non-AP STA has established with its associated AP.
channel occupancy report: The channel occupancy report may contain information on the channel utilization observed at the non-AP STA.

In some embodiments, a latency statistics report, performance statistics report, and channel occupancy report together can be referred to as a statistics report.

In some embodiments, a latency statistics report may contain information pertaining to a latency cumulative distribution function (CDF) based on latency data measured at the non-AP STA side for uplink traffic. In some embodiments, the latency statistics report may contain different latency percentiles based on the CDF, similar as follows:
5 percentile latency: when sent by a non-AP STA, this value may represent the 5 percentile latency measured at the non-AP STA for the uplink traffic.
25 percentile latency: when sent by a non-AP STA, this value may represent the 25 percentile latency measured at the non-AP STA for the uplink traffic.
50 percentile latency: when sent by a non-AP STA, this value may represent the 50 percentile latency measured at the non-AP STA for the uplink traffic.
75 percentile latency: when sent by a non-AP STA, this value may represent the 75 percentile latency measured at the non-AP STA for the uplink traffic.
80 percentile latency: when sent by a non-AP STA, this value may represent the 80 percentile latency measured at the non-AP STA for the uplink traffic.
85 percentile latency: when sent by a non-AP STA, this value may represent the 85 percentile latency measured at the non-AP STA for the uplink traffic.
90 percentile latency: when sent by a non-AP STA, this value may represent the 90 percentile latency measured at the non-AP STA for the uplink traffic.
95 percentile latency: when sent by a non-AP STA, this value may represent the 95 percentile latency measured at the non-AP STA for the uplink traffic.
99 percentile latency: when sent by a non-AP STA, this value may represent the 99 percentile latency measured at the non-AP STA for the uplink traffic.

In some embodiments, a performance statistics report may contain information pertaining to the connection performance. In some embodiments, such information can include one or more of the following:
successful media access control (MAC) service data unit (MSDU) count: When transmitted by a non-AP STA, the successful MSDU count may indicate the number of MSDUs that have been successfully delivered by the non-AP STA for uplink traffic. In some embodiments, a non-AP STA may regard an MSDU to be successfully delivered if, after sending the MSDU to the AP, the non-AP STA receives a corresponding acknowledgement from the AP for that MSDU.
dropped MSDU count: When transmitted by a non-AP STA, the dropped MSDU count may indicate the number of MSDUs that have been dropped by the non-AP STA for uplink traffic. In some embodiments, a non-AP STA may drop an MSDU if the MSDU delivery time has passed the expiration while waiting in the transmit queue or the delivery bound corresponding to the MSDU has expired.
MSDU retry statistics: When transmitted by a non-AP STA, the MSDU retry statistics may contain different statistics corresponding to MSDUs that have failed initially and have made retry attempts corresponding to uplink traffic.
successful RTS count: When transmitted by a non-AP STA, a successful RTS count may indicate the total number of RTS frames that have been successfully sent to the AP corresponding to uplink traffic. In some embodiments an RTS frame can be regarded to be successfully transmitted to the AP, if the non-AP STA has received a corresponding acknowledgment frame from the AP for that RTS frame. The Ack frame can be a CTS frame.
request to send (RTS) retry count: The RTS retry count may indicate the total number of retry attempts for sending an RTS frame.

In some embodiments, MSDU retry statistics may include statistics based on the CDF of the number of retry attempts for each MSDU transmitted. In some embodiments such information may include one or more of the following:
5 percentile retry attempts: when transmitted by a non-AP STA, this value may represent the 5 percentile retry attempts for MSDUs
10 percentile retry attempts: when transmitted by a non-AP STA, this value may represent the 10 percentile retry attempts for MSDUs
25 percentile retry attempts: when transmitted by a non-AP STA, this value may represent the 25 percentile retry attempts for MSDUs
50 percentile retry attempts: when transmitted by a non-AP STA, this value may represent the 50 percentile retry attempts for MSDUs
75 percentile retry attempts: when transmitted by a non-AP STA, this value may represent the 75 percentile retry attempts for MSDUs
80 percentile retry attempts: when transmitted by a non-AP STA, this value may represent the 80 percentile retry attempts for MSDUs
85 percentile retry attempts: when transmitted by a non-AP STA, this value may represent the 85 percentile retry attempts for MSDUs
90 percentile retry attempts: when transmitted by a non-AP STA, this value may represent the 90 percentile retry attempts for MSDUs
95 percentile retry attempts: when transmitted by a non-AP STA, this value may represent the 95 percentile retry attempts for MSDUs
99 percentile retry attempts: when transmitted by a non-AP STA, this value may represent the 99 percentile retry attempts for MSDUs

In some embodiments, a non-AP STA can send a statistics report to its associated AP on a per traffic identifier (TID) basis. In embodiments such as these, all the information carried in the statistics report, including a latency statistics report, can correspond to a particular TID.

In some embodiments, a non-AP STA can send a statistics report to its associated AP based on more than one TID. In embodiments such as these, all the information carried in the statistics report, including a latency statistics report, may correspond to one or more TIDs. The non-AP STA, when sending the statistics report to the AP, may also indicate the set of TIDs that correspond to the statistics report.

In some embodiments, a non-AP STA can send a statistics report to its associated AP on a per SCS identifier (SCS ID) basis if the non-AP STA has established an SCS stream with the AP through SCS negotiation. In embodiments such as these, all the information carried in the statistics report, including a latency statistics report, may correspond to a particular SCS ID.

In some embodiments, a non-AP STA can send a statistics report to its associated AP based on more than one SCS identifier (SCS ID) if the non-AP STA has established SCS streams with the AP through SCS negotiation. In embodiments such as these, all the information carried in the statistics report, including a latency statistics report, may correspond to one or more SCS IDs. The non-AP STA, when sending the statistics report to the AP, may also indicate the set of SCS IDs that correspond to the statistics report.

In some embodiments, for the scenario where a non-AP MLD is associated with an AP MLD and the non-AP MLD establishes one or more links with the AP MLD, the non-AP MLD can send a statistics report corresponding to the connection to the associated AP MLD.

In some embodiments, when a non-AP MLD sends a statistics report to an AP MLD, the statistics report can be on an MLD level. For example, in some embodiments all the latency statistics may be measured at the MLD level and reported to the AP MLD. In some other embodiments, when a non-AP MLD sends a statistics report to an AP MLD, the statistics report can be on an link level. For example, in some embodiments the non-AP MLD can indicate that a statistics report sent to the AP MLD corresponds to a particular link or a particular set of links established between the AP MLD and the non-AP MLD.

In some embodiments, a statistics report can be included in a new element. For example, in some embodiments, the statistics report can be included in a statistics report element, where the statistics report element can be included in a new management frame, such as a statistics report frame.

In some embodiments, upon receiving a statistics report from an associated non-AP MLD, an AP MLD can either send in response an acknowledgment frame or can send a frame asking for more information pertaining to the measurement statistics for the non-AP MLD.

In some embodiments, a non-AP MLD may set up one or more SCS streams with an associated AP MLD before sending a statistics report to the AP MLD.

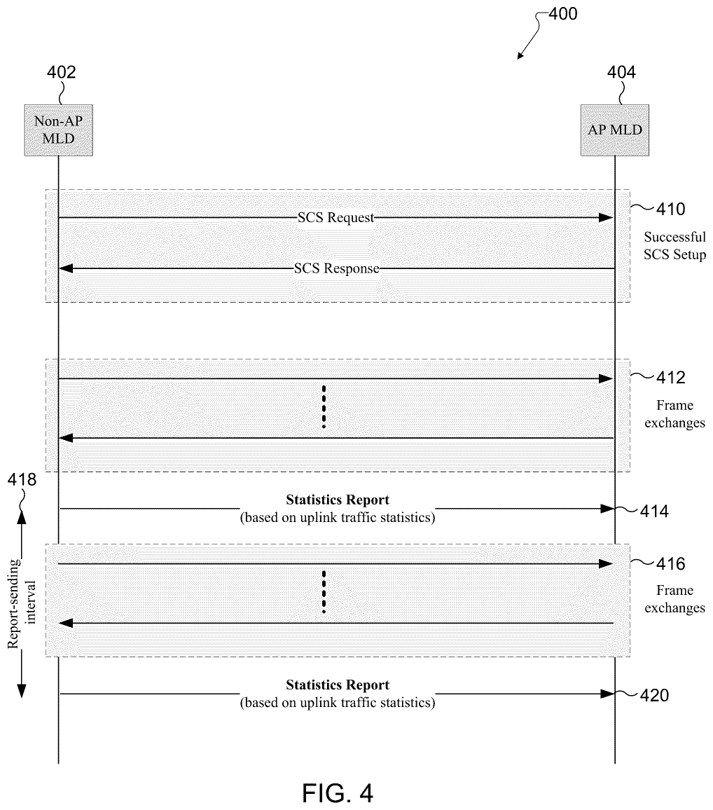

In some embodiments, a non-AP MLD may send a statistics report to an AP MLD based on uplink traffic, where the report can be sent to the AP MLD in a periodic manner with a certain report-sending interval, similar as shown in FIG. 4.

FIG. 4 illustrates an example 400 of statistics report sharing according to embodiments of the present disclosure. The embodiment of statistics report sharing of FIG. 4 is for illustration only. Different embodiments of statistics report sharing could be used without departing from the scope of this disclosure.

The statistics report sharing example of FIG. 4, begins at step 410. At step 410, a non-AP MLD 402 transmits an SCS request to an AP MLD 404, and AP MLD 404 transmits an SCS response to non-AP MLD 402, resulting in a successful SCS setup. In some embodiments, the SCS setup may setup one or more SCS streams between non-AP MLD 402 and AP MLD 404.

At step 412, non-AP MLD 402 and AP MLD 404 exchange a number of frames. After the exchange of frames, at step 414, non-AP MLD 402 transmits a statistics report based on the frame exchanges at step 412 to AP MLD 404. The statistics reports may include at least one information set. For example, the at least information set may include a latency statistics report, a performance statistics report, and a channel occupancy report.

At step 416, non-AP MLD 402 and AP MLD 404 exchange another number of frames for a report sending interval 418. Upon reaching the report sending interval 418, at step 420, non-AP MLD 402 transmits another statistics report based on the frame exchanges at step 416 to AP MLD 404.

Although FIG. 4 illustrates one example 400 of statistics, various changes may be made to FIG. 4. For example, various changes to the report sending interval could be made, etc. according to particular needs.

The analytics statistics request and setup procedure for existing wireless networks is unclear and not well defined. The present disclosure provides mechanisms and frameworks for setting up analytics reporting services between two MLDs.

In some embodiments, a first MLD can request a latency and analytics statistics report from a second MLD. The latency and analytics statistics report may pertain to a particular connection between the first MLD and the second MLD. Such a report may be referred to herein as an analytics report. A service that enables analytics report sharing between two non-AP MLDs may be referred to herein as analytics reporting services (ARS). In some embodiments, the first MLD can be either an AP MLD or a non-AP MLD, and the second MLD can either be an AP MLD or a non-AP MLD.

In some embodiments, a first MLD can send a latency and analytics statistics report to a second MLD. The latency statistics report may pertain to a particular connection between the first MLD and the second MLD. In some embodiments, the first MLD can be either an AP MLD or a non-AP MLD, and the second MLD can either be an AP MLD or a non-AP MLD. In some embodiments, upon receiving a request from a second MLD to provide a latency statistics report to the first MLD, the first MLD can send the latency statistics report to the second MLD.

In some embodiments, if a first MLD intends to request a latency and analytics statistics report from a second MLD, the first MLD can send a frame to the second MLD in order to indicate the request. Such a frame may be referred to herein as an analytics report request frame. In some embodiments, an analytics report request frame can be a management frame or an action frame. In some embodiments, there can be an indication in the analytics report request frame that would indicate that the frame represents a request for a latency/analytics report. In some embodiments, the first MLD can request multiple sets of latency and analytics related information from the second MLD using the analytics report request frame.

In some embodiments, when a first MLD receives an analytics report request from a second MLD, the first MLD can respond by sending an analytics report response frame to the second MLD. For example, the analytics report response frame may indicate how the first MLD responds to the request received from the second MLD. In some embodiments the analytics report response frame may indicate one of the following:
accept: If the first MLD accepts to provide all sets of information (i.e., a full report) requested by the second MLD.
reject: If the first MLD rejects to provide any set of information requested by the analytics report request frame.
partial accept: If the first MLD accepts to provide only a subset of information requested by the analytics report request frame.

In some embodiments, at least one of an analytics report request frame and an analytics report response frame may indicate whether a requested report is to be provided in a periodic manner, a solicited manner, or a threshold manner, similar as follows:
periodic report: a Periodic report would be provided to the requesting MLD in a periodic manner.
solicited report: A first MLD would provide such a report upon receiving a report request from the second MLD.
threshold report: A first MLD would provide such a report to the second MLD if the value of a certain latency or analytics metric falls below a certain threshold or rises above a certain threshold. In some embodiments, information on the indicated metric as well as the corresponding threshold value may be included in at least one of an analytics report request frame and an analytics report response frame.

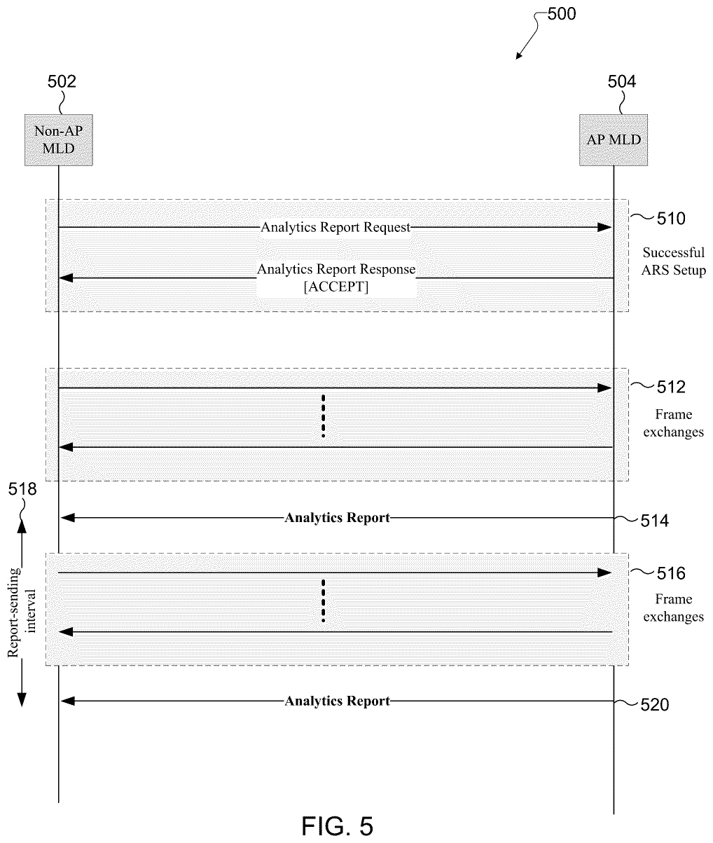

An example frame exchange between an AP MLD and a non-AP MLD for setting up ARS is shown in FIG. 5.

FIG. 5 illustrates an example 500 of ARS setup according to embodiments of the present disclosure. The embodiment of ARS setup of FIG. 5 is for illustration only. Different embodiments of ARS setup could be used without departing from the scope of this disclosure.

The ARS setup example of FIG. 5, begins at step 510. At step 510, a non-AP MLD 502 transmits an analytics report request to an AP MLD 504, and AP MLD 504 transmits an report response with an acceptance to non-AP MLD 502, resulting in a successful ARS setup. In some embodiments, the analytics report request may pertain to a particular connection between non-AP MLD 502 and AP MLD 504. In some embodiments, the request for the analytics report may be a request for a periodic analytics report.

At step 512, non-AP MLD 502 and AP MLD 504 exchange a number of frames. After the exchange of frames, at step 514, non-AP MLD 502 receives an analytics report from AP MLD 404. In some embodiments, the analytics report may pertain to a particular connection between non-AP MLD 502 and AP MLD 504.

At step 516, non-AP MLD 502 and AP MLD 504 exchange another number of frames for a report sending interval 518. Upon reaching the report sending interval 518, at step 520, non-AP MLD 502 receives another analytics report from AP MLD 504. In some embodiments, the analytics report may pertain to a particular connection between non-AP MLD 502 and AP MLD 504.

Although FIG. 5 illustrates one example 500 of ARS setup, various changes may be made to FIG. 5. For example, various changes to the report sending interval could be made, etc. according to particular needs.

In some embodiments, if an MLD supports analytics reporting services, the MLD can indicate this capability to other MLDs.

In some embodiments, if an AP MLD supports analytics reporting services, the AP MLD can indicate this capability to other non-AP MLDs.

In some embodiments, if an ultra high reliability (UHR) AP MLD supports analytics reporting services, then the AP MLD can indicate this support using a field (e.g., an ARS Support field) in a UHR capabilities element that the AP MLD transmits. For example, if the ARS Support field is set to 1, this may indicate that the AP MLD supports analytics reporting services. Otherwise, the AP MLD may not support analytics reporting services. In some embodiments, the UHR capabilities element transmitted by the AP MLD carrying the indication indicating ARS support can be included in one of the following:
beacon frame
probe response frame
association response frame
reassociation response frame

In some embodiments, if a UHR non-AP MLD supports analytics reporting services, then the non-AP MLD can indicate this support using a field (e.g., an ARS support field) in a UHR Capabilities element that the non-AP MLD transmits. For example, if the ARS Support field is set to 1, this may indicate that the non-AP MLD supports analytics reporting services. Otherwise, the non-AP MLD may not support analytics reporting services. In some embodiments, the UHR capabilities element transmitted by the non-AP MLD carrying the indication indicating ARS support can be included in one of the following:
probe request frame
association request frame
reassociation request frame

In some embodiments, if a Wi-Fi QoS Management AP MLD supports analytics reporting services, then the AP MLD can indicate this using a field (e.g., an analytics report field) in the capabilities field in a Wi-Fi Alliance Capabilities element. For example, if the analytics report field in the capabilities field in the Wi-Fi Alliance Capabilities element is set to 1, then this may indicate that the AP MLD supports analytics report sharing/services. Otherwise, the AP MLD may not support this report sharing/services. In some embodiments, the Wi-Fi Alliance Capabilities element transmitted by the AP MLD carrying the indication indicating ARS support can be included in one of the following:
beacon frame
probe response frame
association response frame
reassociation response frame

In some embodiments, if a Wi-Fi QoS Management non-AP MLD supports analytics reporting services, then the non-AP MLD can indicate this using a field (e.g., an analytics report field) in the capabilities field in the Wi-Fi Alliance Capabilities element. For example, if the analytics report field in the capabilities field in the Wi-Fi Alliance Capabilities element is set to 1, then this may indicate that the non-AP MLD supports analytics report sharing/services; otherwise, the non-AP MLD may not support this report sharing/services. In some embodiments, the Wi-Fi Alliance Capabilities element transmitted by the AP MLD carrying the indication indicating ARS support can be included in one of the following:
probe request frame
association request frame
reassociation request frame

In some embodiments, bit 4 of the capabilities field of the Wi-Fi Alliance Capabilities element may represent the capabilities/support for analytics report sharing/services. An example of a possible format of the capabilities field of the Wi-Fi Alliance Capabilities element is shown in Table 1.

TABLE 1
Capabilities field bit assignment

| Bit | Meaning | Reference |
|---|---|---|
| 0 | QoS Management DSCP Policy | Wi-Fi QoS Management |
| | | Specification R3 |
| 1 | QoS Management Unsolicited DSCP | Wi-Fi QoS Management |
| | Policy At Association | Specification R3 |
| 2 | QoS Management SCS Traffic | Wi-Fi QoS Management |
| | Description | Specification R3 |
| 3 | 5G QoS to Wi-Fi QoS Mapping | Wi-Fi QoS Management |
| | | Specification R3 |
| 4 | Analytics Report | Wi-Fi QoS Management |
| | | Specification R3 |

In some embodiments, bit 5 of the capabilities field of the Wi-Fi Alliance Capabilities element may represent the capabilities/support for analytics report sharing/services. An example of a possible format of the capabilities field of the Wi-Fi Alliance Capabilities element is shown in Table 2.

TABLE 2
Capabilities field bit assignment

| Bit | Meaning | Reference |
|---|---|---|
| 0 | QoS Management DSCP Policy | Wi-Fi QoS Management |
| | | Specification R3 |
| 1 | QoS Management Unsolicited DSCP | Wi-Fi QoS Management |
| | Policy At Association | Specification R3 |
| 2 | QoS Management SCS Traffic | Wi-Fi QoS Management |
| | Description | Specification R3 |
| 3 | 5G QoS to Wi-Fi QoS Mapping | Wi-Fi QoS Management |
| | | Specification R3 |
| 4 | Reserved | Reserved |
| 5 | Analytics Report | Wi-Fi QoS Management |
| | | Specification R3 |

In some embodiments, any bit position in the capabilities field in the Wi-Fi Alliance Capabilities element other than the values between 0 and 3 can be used to indicate the capabilities/support for analytics report sharing/services.

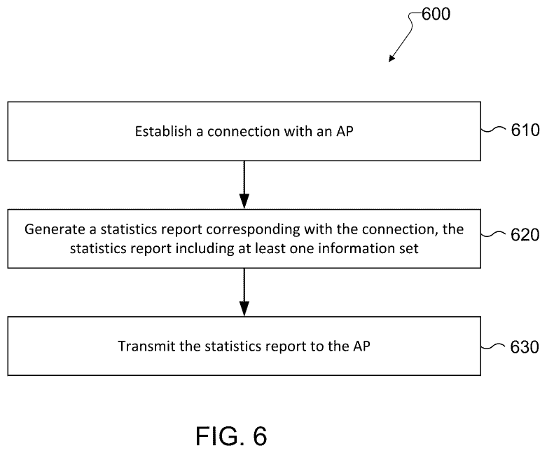

FIG. 6 illustrates an example method 600 for analytics reporting services negotiation and setup according to embodiments of the present disclosure. An embodiment of the method illustrated in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments of a method for analytics reporting services negotiation and setup could be used without departing from the scope of this disclosure.

In the example of FIG. 6, method 600 begins at step 610. At step 610, a STA (such as non-AP MLD 402 of FIG. 4) establishes a connection with an AP (such as AP MLD 404 of FIG. 4). For example, the connection may be established similarly as shown in step 410 of FIG. 4.

At step 620, the STA generates a statistics report corresponding with the connection. The statistics report includes at least one information set. For example, the information set could include information from a frame exchange similar as shown in step 412 of FIG. 4. In some embodiments, the at least one information set may include at least one of a latency statistics report, a performance statistics report, and a channel occupancy report. In some embodiments, prior to generating the statistics report, the STA may setup one or more SCS streams with the AP.

At step 630, the STA transmits the statistics report to the AP. For example, the transmission could be similar as shown in step 414 of FIG. 4. In some embodiments, the statistics report may be transmitted to the AP during a report-sending interval. For example, the report-sending interval may be similar to report sending interval 418 of FIG. 4.

In some embodiments, the STA may be a first MLD, and the AP may be a second MLD. In embodiments such as these, the STA may be further configured to (i) transmit, to the AP, a request for an analytics report pertaining to a particular connection between the STA and the AP, and (ii) receive from the AP, the analytics report. In embodiments, such as these, the STA may be further configured to transmit, to the AP, a message including an indication that the STA supports ARS. The message may be one of a beacon frame, a probe response frame, an association response frame, and a reassociation response frame. In some embodiments, the first MLD may be at least one of a UHR non-AP MLD and a Wi-Fi QoS management non-AP MLD. In some embodiments, the second MLD may be at least one of an ultra high reliability (UHR) AP MLD and a Wi-Fi QoS management AP MLD.

In some embodiments, the STA may be a first MLD, and the AP may be a second MLD. In embodiments such as these, the STA may be further configured to transmit an analytics report pertaining to a particular connection between the STA and the AP. In embodiments such as these, the STA may be further configured to (i) receive, from the AP, a request for the analytics report pertaining to the particular connection between the STA and the AP, and (ii) transmit the analytics report in response to receipt of the request. In some embodiments, the request for the analytics report may be a request for a periodic analytics report, and the STA may transmit the analytics report during a report-sending interval.

Although FIG. 6 illustrates one example method 600 for analytics reporting services negotiation and setup, various changes may be made to FIG. 6. For example, while shown as a series of steps, various steps in FIG. 6 could overlap, occur in parallel, occur in a different order, occur any number of times, be omitted, or replaced by other steps.

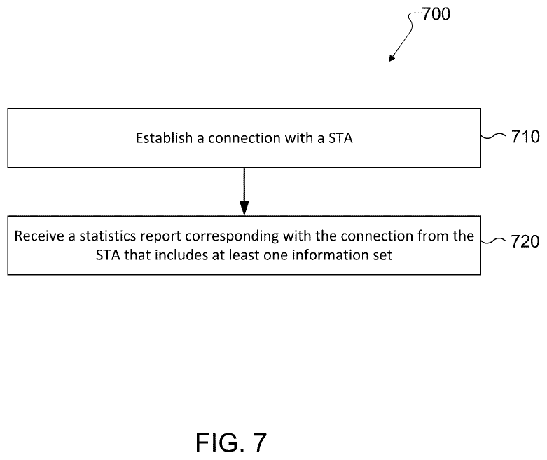

FIG. 7 illustrates another example method 700 for analytics reporting services negotiation and setup according to embodiments of the present disclosure. An embodiment of the method illustrated in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments of a method for analytics reporting services negotiation and setup could be used without departing from the scope of this disclosure.

In the example of FIG. 7, method 700 begins at step 710. At step 710, an AP (such as AP MLD 404 of FIG. 4) establishes a connection with a STA (such as non-AP MLD 402 of FIG. 4). For example, the connection may be established similarly as shown in step 410 of FIG. 4.

At step 720, the AP receives a statistics report from the STA. For example, the reception could be similar as shown in step 414 of FIG. 4. The statistics report includes at least one information set. For example, the information set could include information from a frame exchange similar as shown in step 412 of FIG. 4. In some embodiments, the at least one information set may include at least one of a latency statistics report, a performance statistics report, and a channel occupancy report. In some embodiments, the statistics report may be transmitted to the AP during a report-sending interval. For example, the report-sending interval may be similar to report sending interval 418 of FIG. 4. In some embodiments, prior to receiving the statistics report from the STA, the AP may setup one or more SCS streams with the STA.

In some embodiments, the STA may be a first MLD, and the AP may be a second MLD. In embodiments such as these, the AP may be further configured to (i) receive, to the STA, a request for an analytics report pertaining to a particular connection between the STA and the AP, and (ii) transmit to the STA, the analytics report. In embodiments, such as these, the AP may be further configured to receive, to the STA, a message including an indication that the STA supports ARS. The message may be one of a beacon frame, a probe response frame, an association response frame, and a reassociation response frame. In some embodiments, the first MLD may be at least one of a UHR non-AP MLD and a Wi-Fi QoS management non-AP MLD. In some embodiments, the second MLD may be at least one of a UHR AP MLD and a Wi-Fi QoS management AP MLD.

In some embodiments, the STA may be a first MLD, and the AP may be a second MLD. In embodiments such as these, the AP may be further configured to receive an analytics report pertaining to a particular connection between the STA and the AP. In embodiments such as these, the AP may be further configured to (i) transmit, to the STA, a request for the analytics report pertaining to the particular connection between the STA and the AP, and (ii) receive the analytics report in response to receipt of the request by the STA. In some embodiments, the request for the analytics report may be a request for a periodic analytics report, and the AP may receive the analytics report during a report-sending interval.

Although FIG. 7 illustrates one example method 700 for analytics reporting services negotiation and setup, various changes may be made to FIG. 7. For example, while shown as a series of steps, various steps in FIG. 7 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A station (STA) comprising:
a processor configured to:
establish a connection with an access point (AP); and
generate a statistics report corresponding with the connection, the statistic report including at least one information set; and
a transceiver operably coupled to the processor, the transceiver configured to transmit the statistics report to the AP.

2. The STA of claim 1, wherein the at least one information set includes at least one of:
a latency statistics report;
a performance statistics report; and
a channel occupancy report.

3. The STA of claim 1, wherein:
the processor is further configured to, prior to generating the statistics report, setup one or more stream classification service (SCS) streams with the AP; and
the transceiver is configured to transmit the statistics report to the AP during a report-sending interval.

4. The STA of claim 1, wherein:
the STA is a first multi-link device (MLD);
the AP is a second MLD; and
the transceiver is further configured to:
transmit, to the AP, a request for an analytics report pertaining to a particular connection between the STA and the AP; and
receive from the AP, the analytics report.

5. The STA of claim 4, wherein the transceiver is further configured to transmit, to the AP, a message including an indication that the STA supports analytics reporting services (ARS).

6. The STA of claim 5, wherein the message is one of:
a beacon frame;
a probe response frame;
an association response frame; and
a reassociation response frame.

7. The STA of claim 4, wherein:
the first MLD is at least one of a ultra high reliability (UHR) non-AP MLD and a Wi-Fi quality of service (QoS) management non-AP MLD; and
the second MLD is at least one of a UHR AP MLD and a Wi-Fi QoS management AP MLD.

8. The STA of claim 1, wherein:
the STA is a first multi-link device (MLD);
the AP is a second MLD; and
the transceiver is further configured to transmit an analytics report pertaining to a particular connection between the STA and the AP.

9. The STA of claim 8, wherein:
the transceiver is further configured to:
receive, from the AP, a request for the analytics report pertaining to the particular connection between the STA and the AP; and
transmit the analytics report in response to receipt of the request.

10. The STA of claim 9, wherein:
the request for the analytics report is a request for a periodic analytics report; and
the transceiver is further configured to transmit the analytics report during a report-sending interval.

11. An access point (AP) comprising:
a processor configured to establish a connection with a station (STA); and
a transceiver operably coupled to the processor, the transceiver configured to receive a statistics report corresponding with the connection from the STA,
wherein the statistics report includes at least one information set.

12. The AP of claim 11, wherein the at least one information set includes at least one of:
a latency statistics report;
a performance statistics report; and
a channel occupancy report.

13. The AP of claim 11, wherein:
the processor is further configured to, prior to receiving the statistics report, setup one or more stream classification service (SCS) streams with the STA; and
the transceiver is configured to receive the statistics report from the STA during a report-sending interval.

14. The AP of claim 11, wherein:
the STA is a first multi-link device (MLD);
the AP is a second MLD; and
the transceiver is further configured to:
receive, from the STA, a request for an analytics report pertaining to a particular connection between the STA and the AP; and
transmit to the STA, the analytics report.

15. The AP of claim 14, wherein the transceiver is further configured to receive, from the STA, a message including an indication that the STA supports analytics reporting services (ARS).

16. The AP of claim 15, wherein the message is one of:
a beacon frame;
a probe response frame;
an association response frame; and
a reassociation response frame.

17. The AP of claim 14, wherein:
the first MLD is at least one of a ultra high reliability (UHR) non-AP MLD and a Wi-Fi quality of service (QoS) management non-AP MLD; and
the second MLD is at least one of UHR AP MLD and a Wi-Fi QoS management AP MLD.

18. The AP of claim 11, wherein:
the STA is a first multi-link device (MLD);
the AP is a second MLD; and
the transceiver is further configured to receive an analytics report pertaining to a particular connection between the STA and the AP.

19. The AP of claim 18, wherein:
the transceiver is further configured to:
transmit, to the STA, a request for the analytics report pertaining to the particular connection between the STA and the AP; and
receive the analytics report in response to receipt of the request by the STA.

20. The AP of claim 19, wherein:
the request for the analytics report is a request for a periodic analytics report; and
the transceiver is further configured to receive the analytics report during a report-sending interval.
